(19) United States
(12) Patent Application Publication
(10) Pub. No.: US 2025/0245300 A1
(43) Pub. Date: Jul. 31, 2025

(54) CONTENT WALLET AND SYSTEM FOR ISSUING ORIGINAL DATA AND PREVENTING ILLEGAL DATA SHARING USING THE SAME

(71) Applicant: Oh Gyoung GWON, Gyeonggi-do (KR)

(72) Inventor: Oh Gyoung GWON, Gyeonggi-do (KR)

(21) Appl. No.: 19/182,657

(22) Filed: Apr. 18, 2025

Related U.S. Application Data
(63) Continuation of application No. PCT/KR2022/015958, filed on Oct. 19, 2022.

(51) Int. Cl. G06F 21/10; H04L 9/40

(52) U.S. Cl. CPC G06F 21/1085; H04L 63/0428; H04L 63/0876

(57) ABSTRACT

A content wallet and a system for issuing original data and preventing illegal data sharing using the same, according to a preferred embodiment of the present invention, may enable an original data holder of digital content to master and prove a copyright by himself or herself.

### CROSS-REFERENCE TO RELATED APPLICATION

This application is a U.S. Bypass Continuation Application of International Application No. PCT/KR2022/015958, filed on Oct. 19, 2022, the disclosure of which is incorporated herein by reference in its entirety.

### BACKGROUND

### Technical Field

The present invention relates to a content wallet and a system for issuing original data and preventing illegal data sharing using the same, and more particularly, to a content wallet and a system that specify an original storage of content and prove whether the related issued data is being legitimately distributed.

### Background Art

The popularization of the IT industry has brought about many changes in everyday life. Recently, cloud and digital platform technology companies have grown rapidly and are leading the data-driven finance ecosystem. In this process, there has clearly been a contribution from the digital content industry. However, the economic position of relevant personnel including creators is gradually diminishing. In particular, in case of digital audio sources, the individual sales price has continuously declined, to the extent that it is now sold at a price close to free. This leads to a vicious cycle throughout the content industry, including the outflow of talented individuals, the general lowering of content quality, and the spread of disregard for creators.

Such a distorted form of content market has largely been caused by digital platform business operators. Most of these business operators operate based on a custody method in which data is stored in a centralized storage with delegated user authority. Further, the business operators set content prices at free or extremely low levels and utilize the content as representative bait products for making a profit in other areas. This is a clear act of market disruption that infringes upon the right to survival of professionals in different types of industries. However, it is hard to find any movement to point this out or improve upon this.

The entrenchment of this phenomenon may also be attributed to the widespread perception that it is impossible to protect digital copyrights. In case of the content market, there is a characteristic in which content is quickly generated and disappears depending on trends. Its scope is also extremely broad and includes even various transformation cases.

Compared to intellectual property rights such as patents or trademarks, the damage scale of a single product is relatively small, making legal responses difficult in most cases. As a result, lawsuits related to copyrights are mainly used in a limited manner by large-scale business providers such as well-known agencies or artists. Separately from this, there is also a problem in the user interface, which makes it difficult for data owners to easily and intuitively recognize data hacking damage on their own terminals.

Nevertheless, the volume of private transactions of digital content is increasing explosively. However, as most of the transactions take place in formats where protection of rights holders is difficult, many disputes are occurring. First, there is a problem with the dualized intermediary structure in which distribution practitioners and authority agencies exist separately. In reality, since it is impossible for trusted institution representatives to individually monitor the platform-side servers where actual distribution takes place, the effectiveness is questionable. When hacking or illegal leakage damage occurs, this structure also serves as a factor that makes it difficult to identify where responsibility lies. Nevertheless, most digital copyright fees today are primarily settled through private platform companies and executed through public guarantee institutions.

Meanwhile, there have also been attempts to resolve issues of data sovereignty infringement by improving the authority authentication system. Such attempts include proposals for constructing new systems by introducing concepts such as mydata and self-sovereign identity. However, contrary to the original intent, as existing custody business operators or related parties began participating in the standardization process, development has stagnated. In addition, alternatives such as NFTs (non-fungible tokens) or SBTs (soul bound tokens) based on blockchain's distributed ledger are being discussed. However, due to the characteristics of the platforms prioritizing anonymity and investment value, clear limitations have been revealed.

### SUMMARY

### Technical Problem

An object to be achieved by the present invention is to provide a content wallet and

a system for issuing original data and preventing illegal data sharing using the same, in which an original data holder of digital content may master and prove a copyright by himself or herself.

Other objects, which are not explicitly disclosed in the present invention, may be additionally considered within a range in which the objects can be easily derived from the following detailed description and the effects thereof.

### Technical Solution

To achieve the aforementioned technical objects, there is provided a content wallet, according to a preferred embodiment of the present invention. The content wallet includes: a network module connected to a node in a wired or wireless manner; a state check module configured to output a current state; an input/output interface configured to transmit and receive data; an internal memory configured to store the data encrypted through a processing unit; an information output module configured to output the data stored in the internal memory as visual information; and a processing unit configured to perform a function of storing or transmitting metadata related to content.

Here, the processing unit may generate metadata corresponding to content when issuing the content, store the content and the metadata in the internal memory, and transmit the content and the metadata to an external device through the node.

Here, the metadata may include a device unique number, a content identification number, an issue number, a hash value, and a time stamp.

Here, the processing unit may output a signal indicating a physical operation status of a terminal, such as power on/off, data transmission/reception, or network connection status, via the state check module.

Here, the state check module may include one of an LED lamp, a speaker, or a display panel.

Here, the processing unit may perform one operation of an operation of connecting between the network module and the input/output interface, and an operation of not connecting between the network module and the input/output interface, according to a physical manipulation by a user.

Here, the processing unit may be implemented as a physical toggle button, and perform the operation of connecting between the network module and the input/output interface, or the operation of not connecting between the network module and the input/output interface, according to the physical manipulation of the toggle button by the user.

To achieve the aforementioned technical objects, there is provided a system for issuing original data and preventing illegal data sharing using a content wallet, according to a preferred embodiment of the present invention. The system may include: a content wallet; and a server configured to perform a function of authenticating the content wallet, a function of accessing and viewing content through a node connected to the content wallet, and a function of storing and verifying publishing information and republishing information of the content.

Here, the content wallet may include: a network module connected to the node in a wired or wireless manner; a state check module configured to output a current state; an input/output interface configured to transmit and receive data; an internal memory configured to store the data encrypted through a processing unit; an information output module configured to output the data stored in the internal memory as visual information; and a processing unit configured to perform one operation of an operation of connecting between the network module and the input/output interface, or an operation of not connecting between the network module and the input/output interface, according to a physical manipulation by a user.

Here, the processing unit may generate metadata corresponding to content when issuing the content, store the content and the metadata in the internal memory, and transmit the content and the metadata to an external device through the node.

Here, the metadata may include a device unique number, a content identification number, an issue number, a hash value, and a time stamp.

### Advantageous Effects

According to a content wallet and a system for issuing original data and preventing illegal data sharing using the same, in accordance with a preferred embodiment of the present invention, an original data holder of digital content may issue and prove a copyright by himself or herself.

In addition, the present invention may implement a peer-to-peer (P2P) network-specialized trusted execution environment (TEE) by applying an existing trusted execution environment to the relationship between the content wallet and nodes.

In addition, although the present invention uses the computing power of a central processing unit of a node, key specific operations related to data issuance and related meta information may implement true edge computing from the perspective of digital content issuance by using the computing power of a terminal processing unit, which is a processing unit of the content wallet.

In addition, the present invention may be referred to as a true serverless network system from a business perspective, since the content wallet, which operates at the furthest end, performs the most essential operation for authority authentication, and therefore the authority authentication structure is not a top-down structure in which nodes are dependent on a central server.

In addition, by securing not only logical evidence for copyright claims but also physical evidence to prove the same through the system according to the present invention, a user may form a digital content platform and related distribution ecosystem centered on individuals who possess the content wallet.

In addition, existing digital platform providers may pioneer new business areas by developing new services optimized for the authority structure according to the present invention, and when the related infrastructure is established, users may form a holacracy network in which they can communicate in a horizontal position without being dependent on server authority.

The effects of the present invention are not limited to the aforementioned effects, and other effects, which are not mentioned above, will be clearly understood by those skilled in the art from the following description.

### BRIEF DESCRIPTION OF THE DRAWINGS

FIG. 1 is a block diagram for explaining a system for issuing original data and preventing illegal data sharing using a content wallet according to a preferred embodiment of the present invention.

FIG. 2 is a block diagram for explaining a configuration of the content wallet illustrated in FIG. 1.

FIG. 3 is a diagram for explaining a connected-on state of the content wallet illustrated in FIG. 2.

FIG. 4 is a diagram for explaining a connected-off state of the content wallet illustrated in FIG. 2.

FIG. 5 is a diagram for explaining a basic data bus structure of a processing unit of the content wallet illustrated in FIG. 2.

### DETAILED DESCRIPTION

Hereinafter, an embodiment of the present invention will be described in detail with reference to the accompanying drawings. Advantages and features of the present invention and methods of achieving the advantages and features will be clear with reference to embodiments described in detail below together with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims. Throughout the specification, the same reference numerals denote the same constituent elements.

Unless otherwise defined, all terms (including technical and scientific terms) used in the present specification may be used as the meaning which may be commonly understood by the person with ordinary skill in the art, to which the present disclosure belongs. In addition, terms defined in a generally used dictionary shall not be construed in ideal or excessively formal meanings unless they are clearly and specially defined in the present specification.

In this specification. terms such as “first” and “second” are used to distinguish one component from another, and the scope of rights should not be limited by the terms. For example, a first constituent element may be named a second constituent element, and similarly, the second constituent element may be named the first constituent element.

In this specification, the identifiers (e.g., a, b, c, etc.) in each step are for descriptive convenience only, and the identifiers do not describe the order of the steps, and the steps may be performed in any order other than the order described unless the context clearly indicates a specified order. That is, each of the steps may be performed in the same order as specified, may be performed substantially simultaneously, or may be performed in the reverse order.

As used herein, the terms “have,” “may have,” “include,” or “may include” indicate the existence of a feature (e.g., a number, function, operation, or a component such as a part) and do not exclude the existence of other features.

In addition, as described herein, the term ‘unit’, ‘part’, or ‘portion’ means software or a hardware constituent element, such as a field programmable gate array (FPGA) or ASIC, where the term ‘unit’, ‘part’, or ‘portion’ performs some role. However, the term ‘unit’, ‘part’, or ‘portion’ is not limited to software or hardware. The term ‘unit’, ‘part’, or ‘portion’ may be configured to be in an addressable storage medium or configured to reproduce one or more processors. Thus, as an example, the term ‘unit’, ‘part’, or ‘portion’ includes constituent elements such as software constituent elements, object-oriented software constituent elements, class constituent elements, and task components, processes, functions, properties, procedures, subroutines, segments of program codes, drivers, firmware, microcode, circuitry, data structures, and variables. The functions provided in the constituent elements and the term, ‘units’, ‘parts’, or ‘portions’ may be combined into a smaller number of constituent elements, ‘units’, ‘parts’, and ‘portions’ and/or divided into additional constituent elements, ‘units’, ‘parts’, and ‘portions’.

Hereinafter, a preferred embodiment of a content wallet and a system for issuing original data and preventing illegal data sharing using the same according to the present invention will be described in detail with reference to the accompanying drawings.

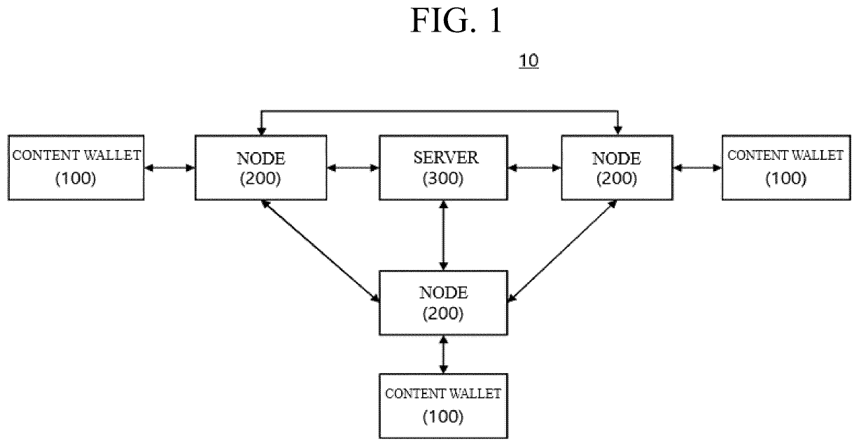

First, with reference to FIG. 1, a system for issuing original data and preventing illegal data sharing using a content wallet according to a preferred embodiment of the present invention will be described.

FIG. 1 is a block diagram for explaining a system for issuing original data and preventing illegal data sharing using a content wallet according to a preferred embodiment of the present invention.

As data transactions through digital platforms have become commonplace, related dispute cases are also increasing. Accordingly, a digital forensics investigation technique, which tracks and analyzes digital devices or data and utilizes the results as legal evidence, is drawing attention. Here, the most representative means being used is a hash value, which is referred to as the ‘fingerprint of digital evidence’. It is a generalized technology that is applied to most existing data. A hash value is determined by applying encryption functions such as AES, SHA, or CRC, and has a characteristic in which a completely different result value is derived even with a slight difference in input values. Accordingly, it is mainly used in cases where it is necessary to determine whether data has been duplicated or tampered with.

On the other hand, it is difficult to find a solution for proving the original author of digital content. In fact, once data is distributed without permission, it is virtually impossible to track its subsequent distribution path. This is because indexing related to data distribution is known to be extremely complex. Currently, most security companies provide solutions to the market by additionally installing dedicated hardware devices or software. However, most of these adopt a method for data custody business of large-scale platforms, and this acts as a factor that hinders market participants suitable for independent activities from entering the market.

Nevertheless, technologies that have the potential to solve the problem of digital content publishing and copyright protection do exist.

First, there is a physical unclonable function (PUF), a standard specification for identifying physical uniqueness. It generates a security key using a principle in which nano-scale semiconductor microstructures are randomly formed without external random number injection (RNG), and it possesses uniqueness like a human fingerprint. For this reason, it is also referred to as the ‘fingerprint of a semiconductor chip’. It has been commercialized mainly in the field of identity authentication for smart devices, SIM cards, IoT products, credit cards, and electronic identification cards, as official standards of the International Organization for Standardization (ISO) and the Global Semiconductor Alliance (GSA).

In addition, a trusted execution environment (TEE), announced by Global Platform, is an internal terminal standard. It is a type of security system design standard that considers both hardware and an operating system (OS). It is currently adopted in most smart terminals and is widely used in the area of identity authentication, such as PIN numbers, biometric information, and passwords. In addition, private standards such as trust-zone (TZ) by ARM are being utilized, and the basic implementation principle is similar to that of a trusted execution environment (TEE).

In addition, there exists DRM, which is a network security system centered on platform companies. Currently, various file formats are being utilized depending on media types, and representative formats include EPUB, PDF, and TXT for documents, JPEG, PNG, GIF, and BMP for visual images. MP3, WAV, and FLAC for audio sources, and MP4, MOV, AVI, MPEG, and WMV for video. The DRM applies its own encryption in advance to such file formats so that the encrypted files may be used only on platforms that support these. However, due to intense competition among private companies, proprietary standards are in disorder, and most have evolved into structures specialized for data custody platforms.

The present invention enables an original data holder of digital content to issue and prove a copyright by himself or herself. To this end, the technical implementation may be promoted in two main aspects: a content wallet, namely a terminal, and a system network. Primarily, a terminal capable of recording and storing original data and confirming related external issuance history needs to be implemented. Subsequently, a network system infrastructure needs to be established in which each terminal may be independently utilized.

With reference to FIG. 1, the present invention will now be described. A system 10 for issuing original data and preventing illegal data sharing using a content wallet according to a preferred embodiment of the present invention may include a content wallet 100 connected to nodes 200 and a server 300 connected to the nodes 200.

Here, each node 200 to which the content wallet 100 is connected in a wired or wireless manner may be connected to other nodes 200 through wireless communication. Further, the server 300 may also be connected to all nodes 200 through wireless communication. In this case, the node 200 refers to a terminal possessed by a user, such as a mobile phone or a smartphone.

That is, the content wallet 100 may perform a data storage function, an identification function, and an issuance function.

More specifically, the content wallet 100 may include a personal data storage (PDS) having physical uniqueness identification capability, and a database management system (DBMS) specialized therefor. Raw data delivered to the content wallet 100 through the node 200 may be converted into a hash value through a processing unit and recorded in memory. In this case, the raw data may be converted into content in which a watermark is inserted or decryption is required for playback. It is also possible to have a method that converts only the hash value without changing the playback area. The original data secured through this process comes to have a hash value different from that of the raw data. In addition, once recorded, the data cannot be arbitrarily deleted or modified, thereby fundamentally blocking the possibility of hacking. Through this, an infrastructure capable of clearly specifying the physical subject of digital issuance may be established.

In addition, the content wallet 100 may provide a database capable of constructing a content publishing system centered on a terminal. Currently, in most countries, copyright is legally considered to be created at the time when it is publicly announced to the public. Since the legal authority over content may vary completely depending on who first publishes the content, it is important to leave a basis for the time of publication. The first external transmission of original data is performed to a node storage directly connected to the terminal, and the meta information of the data first issued through the terminal may be transmitted to a public server. When this meta information is publicly posted after undergoing approval by a trusted institution in charge or a verification process by a public server supporting such a function, the publication is completed. Meanwhile, if the existing publication proof becomes difficult due to inevitable circumstances such as malfunction or loss, the meta information may be recorded and managed under a separate numbering system after undergoing a separate authentication process for proving the same.

In addition, the content wallet 100 may include a content republishing system centered on a terminal. This is to distributively record metadata related to content publishing and republishing inside and outside the terminal. Accordingly, the meta information including a device unique number, a content identification number, an issue number, a hash value, and a time stamp may be distributively stored in the storage inside and outside the terminal with identical content. This is to use the meta information as evidence in the integrity verification procedure when necessary.

Further, the server 300 may perform an authentication function for the content wallet 100, a function of accessing and viewing content through the node 200 connected to the content wallet 100, and a function of storing and verifying publishing information and republishing information of the content.

More specifically, the server 300 may perform a fundamental authority role regarding the use of the terminal. To this end, it is essential to support an activation function for genuine product authentication using a physical uniqueness identification value. This may be implemented by embedding a digital identifier supporting an equipment identity register (EIR) or identification function similar to the EIR in the terminal, and by supporting an authentication service for related credential data. In addition, a dedicated terminal customer center may be operated to immediately respond to reports of malfunctions or losses.

Further, the server 300 may serve as an index provider capable of accessing and viewing content. The server 300 may store the unique identification information of the terminal, meta information for related authentication and verification, record and post the address information of the original data, and perform a related verification role. A platform supporting such a system has an advantage in that, when providing a user search service, it may drastically reduce the risk of data sovereignty infringement due to original ownership and hacking concerns, as well as the burden of security management. Security methods such as VPN or end-to-end encryption may compensate for the infringement of personal information and privacy. On the other hand, individual users may conduct self-directed content transactions, thereby reducing the burden of risks related to privacy and sovereignty infringement.

In addition, the server 300 may perform an agency role of storing and verifying publishing and republishing information of the content. Nodes other than the publishing party node are assigned a role as a distributed storage of related meta information. This means that various verification services such as integrity checks may be provided. In addition, this is a method that may be implemented due to the unique structure of the system according to the present invention, which mediates digital copyright proof and transaction using only metadata. This has an advantage of being relatively free from traffic overload and security vulnerability problems inherent in centralized custody methods.

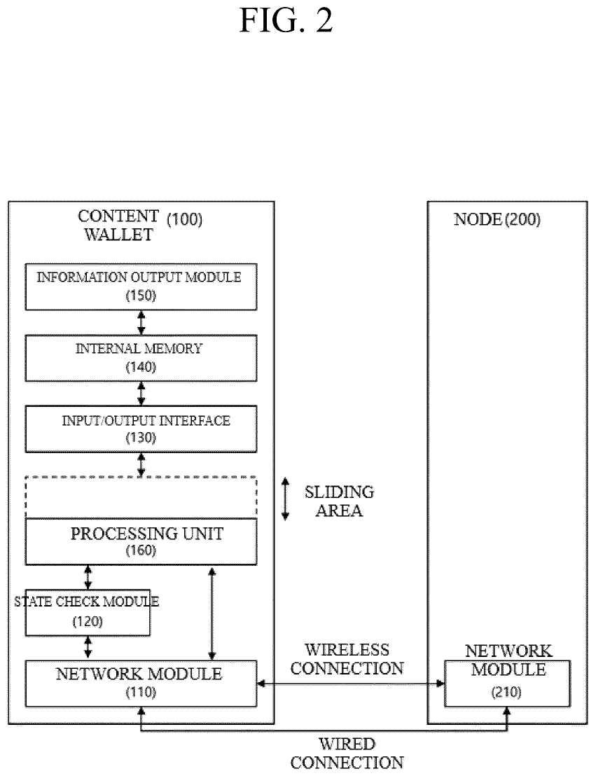

Now, with reference to FIGS. 2 to 5, the content wallet according to a preferred embodiment of the present invention will be described in more detail.

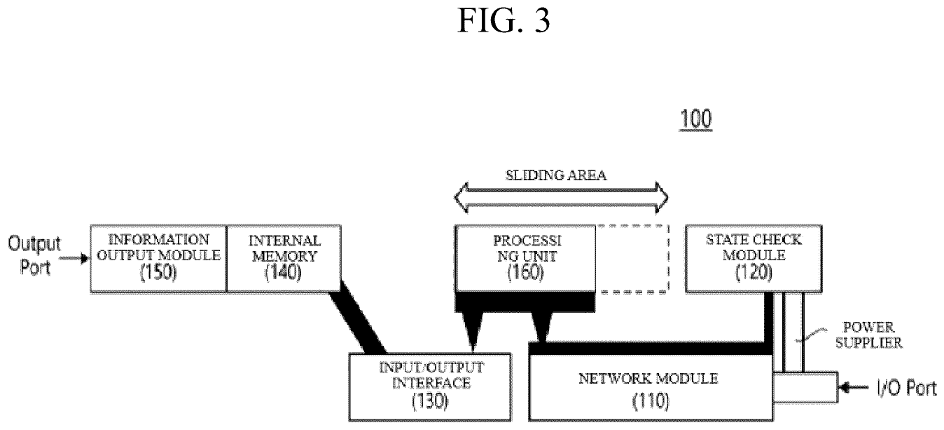

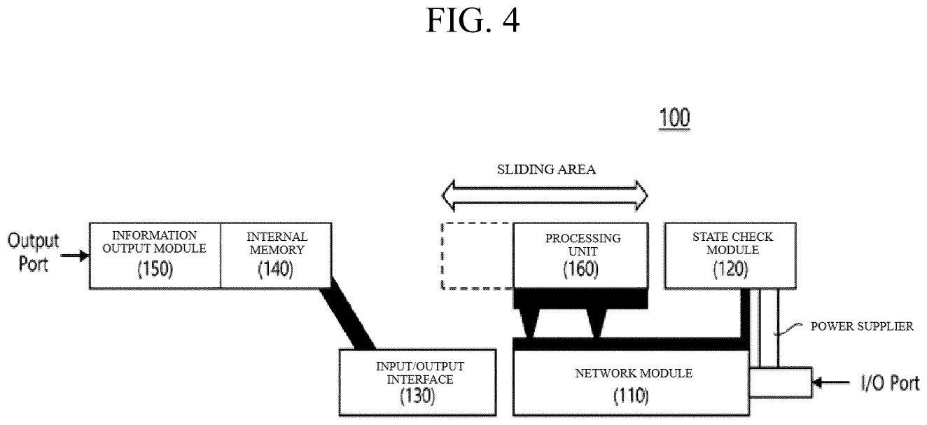

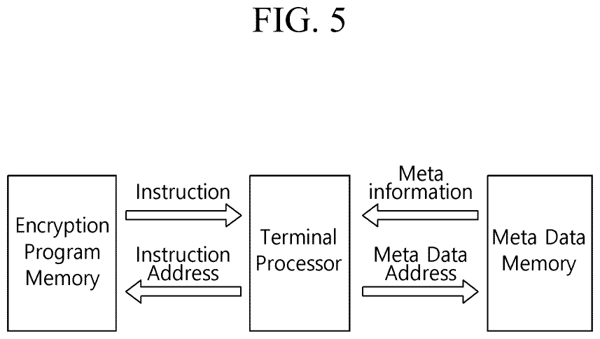

FIG. 2 is a block diagram for explaining a configuration of the content wallet illustrated in FIG. 1, FIG. 3 is a diagram for explaining a connected-on state of the content wallet illustrated in FIG. 2, FIG. 4 is a diagram for explaining a connected-off state of the content wallet illustrated in FIG. 2, and FIG. 5 is a diagram for explaining a basic data bus structure of a processing unit of the content wallet illustrated in FIG. 2.

With reference to FIG. 2, the content wallet 100 may include a network module 110, a state check module 120, an input/output interface 130, an internal memory 140, an information output module 150, and a processing unit 160.

The network module 110 may be connected to the nodes 200 in a wired or wireless manner. That is, the network module 110 may be connected to a network module 210 of the node 200 via wired or wireless communication to transmit and receive data.

The state check module 120 may output a current state of the content wallet 100.

Here, the state check module 120 may include one of an LED lamp, a speaker, or a display panel.

The input/output interface 130 may transmit and receive data.

The internal memory 140 may store data transmitted and received via the input/output interface 130.

The information output module 150 may output data stored in the internal memory 140 as visual information.

Here, the information output module 150 may include a display panel, and may output data in a visual form through the display panel. Of course, the information output module 150 may further include a speaker, and audio information included in the data may also be output in an auditory form through the speaker.

The processing unit 160 may perform one operation of an operation of connecting between the network module 110 and the input/output interface 130, or an operation of not connecting between the network module 110 and the input/output interface 130, according to a physical manipulation by a user.

That is, the processing unit 160 may be implemented as a physical toggle button, and may perform the operation of connecting between the network module 110 and the input/output interface 130 as illustrated in FIG. 3, or may perform the operation of not connecting between the network module 110 and the input/output interface 130 as illustrated in FIG. 4, according to a physical manipulation of the toggle button by a user.

Further, the processing unit 160 may perform a function of storing or transmitting metadata related to content.

That is, when issuing content, the processing unit 160 may generate metadata corresponding to the content, store the content and metadata in the internal memory 140, and transmit the content and metadata to an external device through the node 200.

Here, the metadata may include a device unique number, a content identification number, an issue number, a hash value, and a time stamp.

Further, the processing unit 160 may output a current state regarding one of power on/off, data transmission/reception, or network connection status via the state check module 120.

The main features of the present invention as described above are summarized as follows.

1. A provider owning the content wallet 100 may primarily receive raw data from the node 200 connected to the content wallet 100, convert the raw data through the processing unit 160, and store the converted raw data in the memory 140. The original data generated through this process may be transmitted externally only through the input/output interface 130. The first external transmission of the original data may be stored in the self-node storage. Then, the related information may be transmitted to the server 300 and publication may be completed through public posting.
2. The content provider may transmit issued data or republished data to a consumer. In the data generation process for this, metadata including relevant meta information may be generated together. This metadata may include a device unique number, a content identification number, an issue number, a hash value, and a time stamp. This metadata needs to be simultaneously recorded in the terminals of both the provider and the consumer. This is to verify whether a transaction is legitimate through an integrity check of the corresponding information when necessary.
3. Whereas the existing trusted execution environment (TEE) was a standard technical form for internal use within a single terminal, the present invention may implement the same principle at the external level of a terminal, in a manner that the trusted execution environment (TEE) is established when the node 200 and the content wallet 100 are connected and operated in a P2P manner. Through this invention, it means that terminal manufacturers may develop products by focusing on terminal devices that comply with the secure world standards, while excluding the normal world, which may be implemented with existing smart terminals. This has the advantage of significantly reducing the related labor and manufacturing costs through system semiconductor-centric development that is dedicated to specific operations while maintaining a high level of security.
4. A state indication function of the content wallet 100 may be implemented in real time. This is a form in which a state indication signal output unit is added to the conventional processor based on the von Neumann structure. The information available for output may include power on/off, data transmission/reception, and network connection status. This information may be output by being connected to various devices such as LED lamps, speakers, and display devices. Through this, a user may intuitively recognize the operational state of the content wallet 100 and whether data is being distributed. Additionally, this may help owners to take self-directed measures by making it easier to detect cases of suspected hacking or malfunction of the content wallet 100.
5. An on/off function may be provided through a physical network connection toggle button. Through this, a user may intuitively and fundamentally control whether to share data via the node 200. In addition, even when the physical toggle button is turned off, if the content wallet 100 is connected to the node 200, it is configured such that the device unique number and content list of the seller may be accessed and viewed. Accordingly, using this, a consumer may make a reservation request for content sharing based on the corresponding posted information even before the seller grants approval.

All the constituent elements, which constitute the embodiment of the present invention described above, may be integrally coupled or operate by being combined, but the present invention is not necessarily limited to the embodiment. That is, one or more of the constituent elements may be selectively combined and operated within the object of the present invention. In addition, although all of the constituent elements may each be implemented as independent hardware, some or all of the constituent elements may also be selectively combined and implemented as a computer program having program modules for performing some or all of the combined functions on one or more pieces of hardware. In addition, such a computer program may be stored in a computer readable recording medium, such as a USB memory, a CD disk, or a flash memory, and may be read and executed by a computer to implement an embodiment of the present invention. The recording medium for the computer program may include magnetic recording media, optical recording media, and the like.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

### DESCRIPTION OF REFERENCE NUMERALS

10: System for issuing original data and preventing illegal data sharing
100: Content wallet
110: Network module
120: State check module
130: Input/output interface
140: Internal memory
150: Information output module
160: Processing unit

What is claimed is:

1. A content wallet, comprising:
a network module connected to a node in a wired or wireless manner;
a state check module configured to output a current state;
an input/output interface configured to transmit and receive data;
an internal memory configured to store the data encrypted through a processing unit;
an information output module configured to output the data stored in the internal memory as visual information; and
a processing unit configured to perform a function of storing or transmitting metadata related to content.

2. The content wallet of claim 1, wherein the processing unit generates metadata corresponding to the content when issuing the content, stores the content and the metadata in the internal memory, and transmits the content and the metadata to an external device through the node.

3. The content wallet of claim 2, wherein the metadata includes a device unique number, a content identification number, an issue number, a hash value, and a time stamp.

4. The content wallet of claim 2, wherein the processing unit outputs a signal indicating a physical operation status of a terminal, such as power on/off, data transmission/reception, or network connection status, via the state check module.

5. The content wallet of claim 4, wherein the state check module includes one of an LED lamp, a speaker, or a display panel.

6. The content wallet of claim 2, wherein the processing unit performs one operation of an operation of connecting between the network module and the input/output interface, and an operation of not connecting between the network module and the input/output interface, according to a physical manipulation by a user.

7. The content wallet of claim 6, wherein the processing unit is implemented as a physical toggle button, and performs the operation of connecting between the network module and the input/output interface, or the operation of not connecting between the network module and the input/output interface, according to the physical manipulation of the toggle button by the user.

8. A system for issuing original data and preventing illegal data sharing using a content wallet, the system comprising:
a content wallet; and
a server configured to perform a function of authenticating the content wallet, a function of accessing and viewing content through a node connected to the content wallet, and a function of storing and verifying publishing information and republishing information of the content.

9. The system of claim 8, wherein the content wallet comprises:
a network module connected to the node in a wired or wireless manner;
a state check module configured to output a current state;
an input/output interface configured to transmit and receive data;
an internal memory configured to store the data encrypted through a processing unit;
an information output module configured to output the data stored in the internal memory as visual information; and
a processing unit configured to perform one operation of an operation of connecting between the network module and the input/output interface, or an operation of not connecting between the network module and the input/output interface, according to a physical manipulation by a user.

10. The system of claim 9, wherein the processing unit generates metadata corresponding to content when issuing the content, stores the content and the metadata in the internal memory, and transmits the content and the metadata to an external device through the node.

11. The system of claim 10, wherein the metadata includes a device unique number, a content identification number, an issue number, a hash value, and a time stamp.
